(19) United States
(12) Patent Application Publication
(10) Pub. No.: US 2005/0278760 A1
(43) Pub. Date: Dec. 15, 2005

(54) Method and system for controlling streaming in an on-demand server

(76) Inventors: Don Dewar, Groton, MA (US); Silvia Chirtic, Burlington, MA (US)

Correspondence Address: INTELLECTUAL PROPERTY ADVISORS LLC, PO BOX 156, CANTON, CT, 06019, US

(21) Appl. No.: 11/143,515

(22) Filed: Jun. 1, 2005

Related U.S. Application Data
(60) Provisional application No. 60/576,095, filed on Jun. 1, 2004.
(60) Provisional application No. 60/576,269, filed on Jun. 2, 2004.
(60) Provisional application No. 60/576,338, filed on Jun. 2, 2004.
(60) Provisional application No. 60/576,402, filed on Jun. 2, 2004.

(51) Int. Cl. H04N 7/16; H04N 7/173

(52) U.S. Cl. 725/94; 725/87; 725/92; 725/116; 725/115; 725/145

(57) ABSTRACT

A method and system configured for managing and controlling one or more on-demand servers in order to ingest content files, set-up on-demand sessions at a subscriber request and record status information about the on-demand streams in the operational framework of an on demand service operator (ODSO) with and without the support of the Business Management System (BMS) platform to provide video-on-demand (VOD), subscription video on demand (SVOD), television on demand (TOD), and audio on demand (AOD) services by streaming content to on-demand to a customer. The method can be implemented as software running on an application server with a a web application GUI, a CORBA-based interface to the BMS, a SOAP-based interface to the VOD server, and a set of internal services that glue the other components together on top of an Oracle database all configured to managing and controlling one or more on-demand servers.

This application claims the benefit of U.S. Provisional Application No. 60/576,095, filed Jun. 1, 2004, U.S. Provisional Application No. 60/576,269, filed Jun. 1, 2004, U.S. Provisional Application No. 60/576,338, filed Jun. 1, 2004, and U.S. Provisional Application No. 60/576,402, filed Jun. 1, 2004.

### BACKGROUND OF THE INVENTION

1. Field of the Invention

The present invention relates to method and system for managing and controlling streaming in an on-demand server. More particularly, the present invention provides a centralized tool for asset management, content propagation, configuration and status monitoring, and real-time stream control so as to service simultaneously a large number of streams of audio, video and or other data formats being played out to customers on a network.

2. Description of the Art

In order for an on-demand service operator (ODSO) to provide content to their customers, by way of a video on demand (VOD), television on demand (TOD), subscription video on demand (SVOD), or other on-demand service, the on-demand service operator has to integrate a on-demand server into the operational framework of the network or ODSO distribution system. The main areas of functionality required to deliver the service in the ODSO network or distribution system are: on-demand server provisioning, content ingest management, session setup/stream management, and on-demand service assurance. Heretofore, various proprietary Business Management Systems (BMS) required inordinate labor and equipment to establish and implement an on-demand service. A need developed for an open BMS standard configured to a memory-based on-demand server application.

A open BMS accorded the ISA standard from the Pegasus Time Warner Communications is an integrated BMS platform to provide the service level frame work for services like MOD, PPV. Other standards such as J2EE of Telenet, RTSP by nCube, a combination RTSP plus LSCP of UPC, and RTSP plus XML by NGOD. However, problems arose in implementing the ISA standard as proprietary BMS were configured to proprietary disk-based on-demand servers such as systems from Seachange, Kasenna, Concurrent, Arroyo and the like. Additional costs are associated with such disk-based on-demand systems from programming to maintenance costs. As a result, a need developed for a cost effective, efficient open on-demand server having an open BMS configured to the ISA standard or other open standard. The need is satisfied by the memory-based on-demand server of Broadbus Technologies, Inc., manufactured under the name B-1, as it provides an open BMS platform configured to be integrated and provide video-on-demand (VOD), satellite video on demand (SVOD), television on demand (TOD), and audio on demand (AOD) services by streaming such content to customers requesting the content. Moreover, a need developed for management and control of the massive streaming density of a memory-based on-demand server and other functions as is satisfied by the present invention. The present invention's management and control of the massive streaming density advantageously uses a graphical user interface to provide point-and-click access key functions including: Server Configuration; Asset Management; Content Ingest; Content Propagation; Real-Time Streaming Status and Monitoring; Alarm Management and Problem Resolution; Meaningful Service Statistics; and Customized Reporting.

### SUMMARY OF THE INVENTION

The invention described in the instant application overcomes these limitations and more by providing for a method and system, which permits dynamic manage content in the memory based on-demand server to maximize the streaming to the user interface. The intention can be implemented by one or more software modules to effectuate a client-server file. Some embodiments of the invention also facilitate better designs for devices designed to operate in a manner to enable dynamic bandwidth balancing across multiple, memory based VOD servers so as to maximize concurrency.

Such advantages are achieved using the flexibility of an open protocol platform for the BMS while taking advantage of the dynamic ability of a memory-based on-demand server. In particular, devices connected in an on-demand system can be advantageously be used for reporting, messaging, and other streaming control functions without utilizing bandwidth when carrying out such control functions. In addition, the management and control of streaming is accomplished in a way to conserve bandwidth resources and that devices are able to change their bandwidth requirements dynamically without significantly affecting streaming to users.

It should be understood, as would be apparent to one of ordinary skill in the art, that many embodiments of the invention are possible, which do not necessarily require changes to the operating of a memory-based on-demand server and system, and are not limited to the management and control of streaming.

Additional features and advantages of the invention will be made apparent from the following detailed description of some of the many possible illustrative embodiments which proceeds with reference to the accompanying figures. A method and system is disclosed for dynamic managing of content in a memory-based on-demand server to maximize the streaming to the user interface, maximizing concurrent streams, generating reports, dynamic balancing of on-demand server platforms to balance the content in memory across multiple, memory-based on-demand servers so as to maximize concurrency, memory usage, modeling, reporting and television on demand.

It is an object and advantage of the present invention to manage content in the memory-based on-demand server to maximize the user interface. The method and system may include ingesting, managing and streaming a content object file. The method and system is configured to schedule ingest, utilize RAM memory efficiently, and balance the content object file across and/or between one or more on-demand servers; and is configured to enable direct communications with the BMS, other third party components, and on-demand server components including server, blade and port status. The method and system is configured to maintain concurrency of streams of the content object file; and dynamically control and optimize memory utilization while minimizing access to disk storage by monitoring CAM usage so as to remove the content from resident CAM memory and page the same adaptively and to eliminate creating separate files for trick playback of content streamed to a customer.

It is an object and advantage of the present invention to balance the content in VOD memory across multiple, memory-based on-demand servers so as to maximize concurrency, modeling of concurrency for television on demand, memory usage, and reporting data for streaming content over time.

It is an object and advantage of the present invention to utilize an open interface to be managed by third parties gSOAP, HTTP, RTSP interface in a memory-based on-demand server.

It is an object and advantage of the present invention to ingest and load balance content made available for television-on-demand across multiple, memory-based on-demand servers and multiple ports.

It is an object and advantage of the adaptive open architecture of the present invention in integrating on-demand server, without disrupting our core, to differing BMS protocols.

It is an object and advantage of the present invention to control streams, devices and other server components on a system, blade and port basis to allow for the decommissioning of disabled components prior to scheduling ingests into the memory-based on-demand server.

In the preferred embodiment of the present invention, a system for controlling streaming of content from the memory-based, on-demand server consists of a processor; memory coupled to the processor, where the processor ingests content over a protocol bus; the processor repeatedly (a) establishes a content session for obtaining content by interfacing with a business management system (BMS); (b) ingests content as an object by interfacing with an Asset Management System (AMS) and/or a catcher; and/or (c) ingests movies-on-demand (MOD) applications APPS; and the processor controls the streaming of the content stored in memory of the memory-based on-demand server to a customer on-demand.

### DESCRIPTION OF THE DRAWINGS

These and other advantages of the present invention are best understood with reference to the drawings, in which:

FIG. 1 is a schematic diagram of memory-based on-demand server system in the operational distribution framework of an on demand service operator;

FIG. 2 is a diagram illustrating to method and system for managing and controlling streaming in an on-demand server distribution system;

FIG. 3 is a schematic diagram illustrating controlling streaming with a memory based on-demand server in a cable network distribution system implementation configuration according to an exemplary embodiment of the present invention;

FIG. 4 is a block diagram illustrating a fiber network distribution system configuration according to an exemplary embodiment of the present invention;

FIG. 5 is a schematic diagram illustrating a managed services operator (MSO) metropolitan network distribution system according to an exemplary embodiment of the present invention;

FIG. 6 is a diagram illustrating the ingest sequence of controlling streaming with a memory based on-demand server;

FIG. 7 is a block diagram illustrating the ingest sequence of controlling streaming with a memory based on-demand server;

FIG. 8 is a block diagram illustrating a stream sync and a stream sync refresh of the controlling streaming server with a memory based on-demand server;

FIG. 9 is a schematic diagram illustrating a VOD stream synchronization and ingest with a memory based on-demand server;

FIG. 10 is a schematic diagram illustrating a push of content in a live stream configuration with a memory based on-demand server;

FIG. 11 is a schematic diagram illustrating a push of content in a live stream configuration with a memory based on-demand server;

FIG. 12 is a schematic diagram illustrating an FTP pull and an FTP push of content in a memory based on-demand server;

FIG. 13 is a schematic diagram illustrating a basic clustering of one or more memory based on-demand server;

FIG. 14 is a schematic diagram is a diagram illustrating a basic ingest into a cluster of one or more memory based on-demand server; and

FIG. 15 is a schematic diagram is a diagram illustrating a basic ingest into a cluster of one or more memory based on-demand server.

### DETAILED DESCRIPTION OF THE PREFERRED EMBODIMENT

The system and method for managing and controlling the streaming from an on-demand server of the present invention is configured to utilize, for example, a solid state, memory based, on-demand server manufactured by Broadbus Technologies, Inc. under the tradenames B-1 and SBB-1, into the operational framework an on demand service operator (ODSO) or other network distribution system with and without the support of the Business Management System (BMS) platform to provide video-on-demand (VOD), subscription video on demand (SVOD), television on demand (TOD), and audio on demand (AOD) services by streaming such content to customers requesting the content. The streaming controller of the present invention operates on a server for controlling the memory based, on-demand server, which can be one or more on-demand servers that store content files on an external RAID 5 storage array, consisting of hardware components and integrated software capable of ingesting and streaming content. The streaming controller has many functional units that may be implemented in hardware wired circuitry, by programming a general purpose processor, or by any combination of hardware and software as is illustrated in the drawings and detailed description that show that each of the functional units can correspond to a sequence of instructions stored in memory.

Referring to the description herein some terms should be defined for the benefit and clear understanding of the present invention. The BMS is a network-based application that manages interactive digital product offerings within the Interactive Services Architecture (ISA) headend. The ISA is a Time Warner Pegasus specification that defines a common interface and framework for adding digital video services. As used herein the asset is a content file with supporting metadata that can be ingested into the on-demand server and streamed to a destination STB. Content files typically are digital files containing audio and video encodings as defined by the Moving Pictures Experts Group (MPEG). The design of stream control process application is fully compatible with ISA specification and is independent of the BMS integration. Certain functions and requirements are needed to provide network resource allocation and management & control system (MCS) such as, for example, as deployed in an ISA-conformant cable network. When integrated with an ISA-based cable network, the BMCS is configured to work with other third party devices or entities within the network to identify, reserve, and release the resources needed to deliver content to downstream Set Top Boxes (STBs), DSL and or cable modems. A STB is also known as a Digital Home Communications Terminal (DHCT), which is a computing device capable of receiving and decoding content streams, that typically runs the client-side movie on demand (MOD) application.

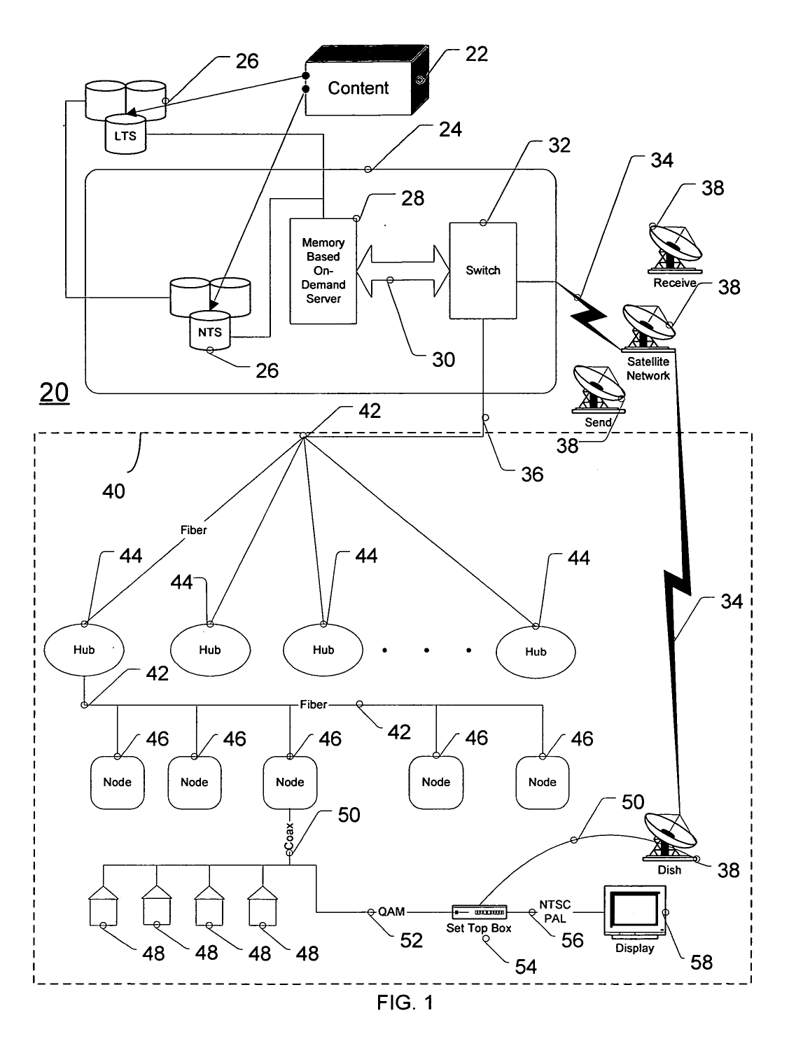

Referring to FIG. 1, a memory based on-demand system is shown generally as element 20. In one embodiment, the memory advantageously can be random access memory (RAM) readily available in 1 Gigabyte or greater chipsets. The memory based on-demand system 20 is configured to distribute content 22 to end users such as, for example, in a network distribution system. A head end 24 of the system 20 obtains content from near- or long-term storage (NTS or LTS) in response to requests sent across the network distribution system by the end user or customer. The head end 24 is generally configured with storage 26, such as disk storage from either NTS or LTS that contains the content to be streamed. A content addressable memory (CAM) based on-demand server 28 such as a B-1 on-demand server or SBB-1 manufactured by Broadbus Technologies, Inc., a wide bus 30 and a switch 32.

Throughout this detailed description content 22 can generally refer to data, audio, visual or audio-visual works such as, for example, a movie file in an MPEG format that is played out to a customer's TV set. It will be appreciated, of course, that the context 22 and examples chosen by the applicant to illustrate the present invention, namely, pulling and playing a movie file to a customer's TV set were chosen for ease of illustrating the principals of the method and system of managing the resources of a RAM based on-demand server according to an exemplary embodiment the present invention. Content 22 also can be obtained and streamed out to a customer in other applications and formats. For example, the content 22 can be another form of data and in another format, specifically, an audio MP3 file. Moreover, data comes in numerous other formats that are streamed to a customer on-demand where it is still advantageous to manage server resources when the server is providing streaming to many, multiple end users in way to display and seamlessly play the requested content 22. As a result, managing information dynamically using a volatile memory based on-demand server across a world-wide network has other applications such as, for example, managing instant messaging, e-mail, streaming video conferencing, audio communications and the like.

Referring to FIG. 1, a head end 24 connects to an on-demand distribution system 20 to distribute content 22 wirelessly 34 or physically on a land line 36, or both. For example, wireless distribution 34 involves connecting the head end 24 to a satellite distribution network 38. Similarly, distribution by land line 36 connects the head end 24 to a high-speed fiber optical network 40 that can be configured, for example, to have high speed fiber optic lines 42, connected to hubs 44, with such hubs 44 connected to nodes 46, and the nodes connected to individual end-users 48, e.g. a particular home or residence. Distribution of content 22 to a particular customer on-demand on a network, for example, network 40. Presently, cable distribution of content 22 to an end user's residence uses coaxial cable 50 via Quaternary/Quadrature Amplitude Modulation (QAM) 52 to a distribution device such a set top box 38 that converts to a NTSC, PAL or other appropriate signal 56 input into an appropriate device 58 that can play out the content 22 such as, for example, a TV, HDTV, LCD, a media center or other displaying device.

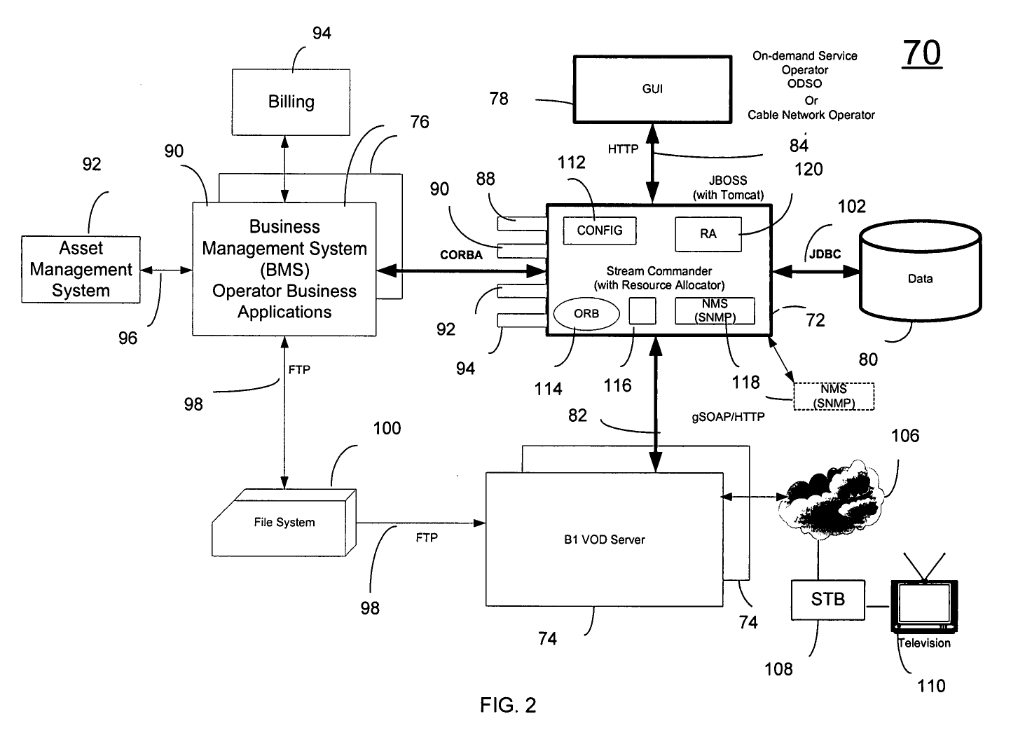

Referring to FIG. 2, an on-demand system 20 of the present invention includes a resource manager 70 having a Stream Controller 72 to provide content 22 by finding and streaming such content 22 to a customer on-demand. The stream controller 72 can be implemented by software, firmware or other so as to connect to one or more VOD or other on-demand servers 74, a business management system (BMS) 76, a graphical user interface (GUI) 78, and a data warehouse 80. The stream commander 72 connects to the on-demand server 74 via a gSOAP interface 82 or HTTP interface 84. The gSOAP interface 82 advantageously is open to management by other third parties. The real time streaming protocol (RTSP) or HTTP interface 84 has advantages as an Internet standard protocol. The BMS 76 advantageously connects to stream commander 76 utilizing various adaptors or protocols from different on-demand network operators (ODNO), whereby ODNO open standards include CORBA or ISA standard 86 published Time Warner and published by N2Broadband, or J2EE 88 published by Telenet, RTSP 90 published by nCUBE, combination protocol RTSP and LSCP 92 published by UPC, and combination protocol RTSP and XML 94 published by NGOD. The BMS 76 is connected to an Asset Management System 92 and Billing System 94 via a standard bus interface 96. The BMS 76 connects to the on-demand server 74 through a file system 100 to effectuate transferring content files by file transfer protocol 98. The GUI 78 connects to streaming controller 72 via a standard HTTP interface 84. The data warehouse 80 connects to stream commander 72 via a JDBC interface 102. Once content 22 has been loaded to the on-demand server 74, it can be streamed under the control of the streaming controller 72 via an interface 104 along a network path 106 to a customer's set top box 108 and displayed on the consumer's television 110.

The streaming controller 72 has several internal processes functioning to configure the system 112 (both the on-demand server 74 and the resource allocator 120), an ORB 114 connection for CORBA, processing error messages and system alarms 116, a network management system (NMS) 118 (typically operating SNMP standard), and the resource allocator 120 configures both adaptive system interfaces ASI and GigE ports. The stream controller's 72 major functions are to (1) configure 112 the on-demand server 74 and provide stream data to the resource allocator 120; (2) to ingest content 22; (3) to stream the content from the on-demand server 74; and (4) monitor system alarms, error messages and SNMP messages.

The streaming controller 72 is configured to control dynamically streaming functions such as, for example, loading content 22 entirely into memory 64, loading portions or segments of content 22 into memory 66, managing near-term-storage (NTS) bandwidth 68 limits and or limitations, and managing of playback functions 70 such as trick play modes and analyzing the speed of playing out the trick play in the stream to customers on-demand. For example, in the on-demand server of the present invention, content 22 demanded by an end user can be either pulled entirely into the memory or pulled into memory in segments from disk storage 26. Information about streams must be maintained for several reasons including recovery information from Resource Allocation status so as to recover, for example, after a failure of the Stream Controller 62. Another reason to maintain information about the streams is more historical so as to maintain information about subscriber behavior like number of trick commands and their type, pause duration, etc.

The Stream Controller 72 records information about active and suspended streams, whereby active streams are streamed from on-demand server 28 and suspended streams are streams for which the session was destroyed but the media file was not streamed up to the end by the Stream Controller 62 such as, for example, when the user resumes watching a paused program content 22 the Stream Controller 72 can provide index information to resume the playback. The Stream Controller 72 operates to receive packages containing assets and MPEG content files sent from a media provider or other asset owner to the cable or satellite network. The cable or satellite network uses a catcher 122 to receive the packages and assets, which the catcher forwards to the asset manager application. The catcher 122 is an application that managers the transfer of packages from the pitcher and then transmits the assets to the on-demand server system. The asset manager application records the association between the assets and their related content files and signals the FTP transfer of the content 22 from the catcher to the on-demand server 28. The Stream Controller 72 maintains the association between the contents 22 and the on-demand server 28 that store them on its NTS 26. The main functionality of the Stream Controller 72 is to:
Implement the Content 22 as an object as per ISA standard and insure persistence.
Maintain information about all of the Content 22 files installed on the on-demand server 28.
Provide functionality to remove Content 22 files.
Create and maintain a unique handle for the content file and forward it to the VOD Server.
Provide the following Content 22 information to the on-demand server 28 including, but not limited to, bit-rate, path (URL containing IP address, user and password), and unique content ID.
Provide persistence for asset and Content 22 information.
Notify the on-demand server 28 about Content 22 ingest request.
Generate an alarm when a Content 22 ingest failed.
Log the Content 22 ingest events.

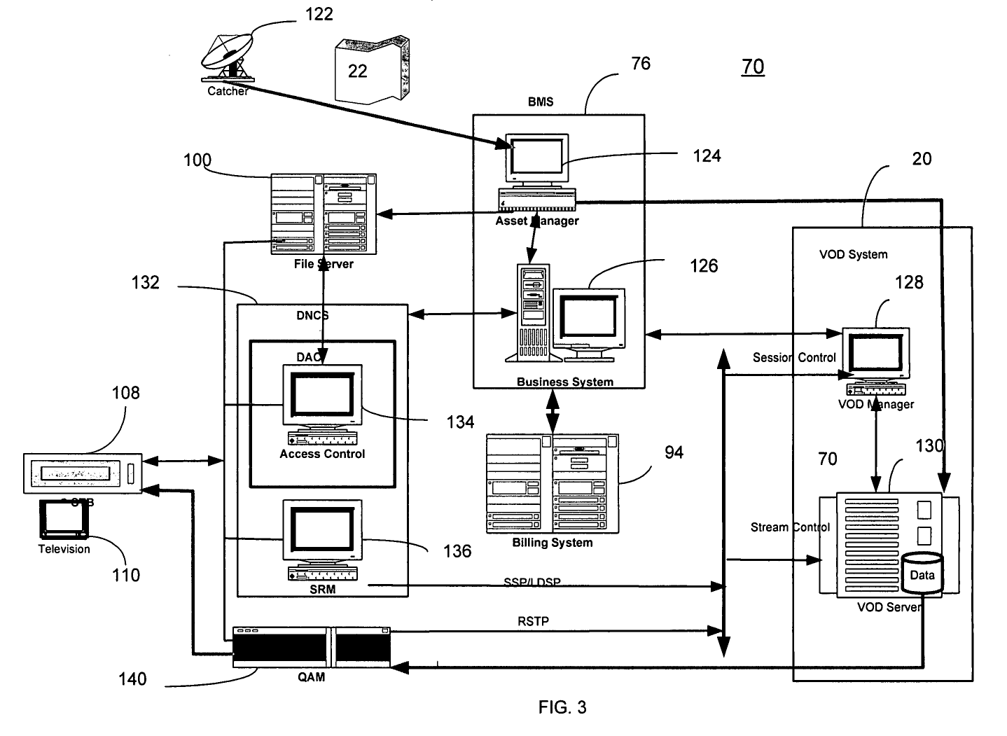

Referring to FIG. 3, an exemplary embodiment of the stream management and control for the on-demand system 20 of the present invention illustrating interaction with the Cable Operator Network and Business System 120. The stream management and control 70 can be implemented as a client-server application to facilitate integration within an Interactive Service Architecture (ISA) head-end and a graphical user interface (GUI) to streamline the provisioning process, fault, configuration, accounting, performance, and security management of one or more memory based, on-demand server 130. The stream management and control process 70 icon be implemented in software running on a dedicated server within the head-end and logically situated between the on-demand server 130 and all third party ISA components such as, for example, the BMS 76 having (1) an asset manager server 124 with connected to the file server 100, catcher 122 and on-demand server 130, (2) the business system 126 with an interfaces to the billing system 94, session control 128, and the DNCS 132 configured with access control server (DAC) 134 and a session resource manager (SRM) 136. The central processing by the stream management and control 70 allows for session control in accessing information and content from the BMS 76, the DNCS 132, and transport stream to import on-demand server 130 as well as stream control of the on demand server 130. Streaming of data to the customer's set top box 108 and television 110 occurs independent of the transport stream typically via cable through a QAM 140.

In the implementation with the cable network operator, the stream controller 22 is configured to control one or more of the on-demand server 130 in order to provide the functionality required to ingest content files, set-up VOD session at subscriber request and record status information about VOD streams. An advantage of the present invention is to integrate and utilize the BMS framework and or system existing at the cable operator site. As illustrated in FIG. 3, the streaming controller 70 controlling the operation of the on the memory-based demand server 130 can be implemented as an enterprise application on a server 128 such as, for example a web application GUI, a CORBA-based interface to the BMS, a SOAP-based interface to the VOD server, and a set of internal services that glue the other components together on top of a database such as, for example, an Oracle database. A catcher 122 is the wireless asset package receiver system, which in the cable system can be a satellite receiver, and in other implementations a dedicated equipment monitoring the stream.

In a hardware context, concurrency is the number of streams requesting a piece of content. Resident content means content entirely contained in the memory of the on-demand server 28. Segment content is a segment, page or tile of content contained in the memory of the on-demand server 28, whereby only a window around the current stream location is kept in memory. A segment, for purposes of this patent application, is an 8 megabyte piece of content 22. Load is meant to indicate making a content 22 resident in the memory of the on-demand server 28. A credit is meant to be a portion or chunk of near-term-storage (NTS) bandwidth (BW), which in the present application is set to a throughput of four (4) megabits-per-second (mbps), which is the rate relating to the number of credits required by the stream. An overlap occurs each time one or more streams use the same segment of content 22 at the same time. A memory limit is a total memory capacity or amount of memory that can be allocated to streaming. A bandwidth limit is a limit of the total bandwidth that can be allocated, whereby setting the bandwidth limit to high may cause trick modes to stall due to unavailable bandwidth BW. A segmented or paging trick play speed limit means the maximum speed a stream that is segmented content 22 is allowed to be played out at in the trick play mode which has an impact on bandwidth requirements.

The system and method for managing and controlling streaming can be configured as software utilizing a web-based graphical user interface advantageously to provide point-and-click access to all of the key functional areas of managing networked memory based on-demand servers including:
Resource Allocation
Server Configuration
Asset Management, Content Ingest, and Content Propagation
Real-Time Streaming Status and Monitoring
Alarm Management and Problem Resolution
Meaningful Service Statistics
Customized Reporting
   The streaming controller software of the present invention runs on a Linux-based or Solaris-based server and uses an Oracle9i SQL relational database for storing configuration profiles, status information, alarms, and statistics. The graphical user interface (GUI) is accessed via a client web browser (Netscape Navigator or Microsoft Internet Explorer). The streaming controller of the present invention advantageously satisfies the need for device configuration, status monitoring as well as a centralized tool for asset management, content propagation, and real-time stream control. The streaming controller software and process is fully ISA-compliant and integrates with any CORBA-based Business Management or Asset Management System, including N2 Broadband's OpenStream™ platform. The streaming controller software and process also works with today's deployed VOD/MOD applications such as the XOD solution from Scientific Atlanta and Pioneer's Showrunner system.

The streaming controller includes a resource allocator that is a subsystem responsible for determining the best path for each stream and negotiating for the required Quaternary/Quadrature Amplitude Modulation (QAM) resources. The resource allocator, using information provided during the provisioning process, formulates a map of all possible stream routes, factors in current stream activity, and calculates the best stream path based on on-demand server and QAM resource utilization.

The streaming controller includes a Session and Resource Manager (SRM), which manages and controls network resources. Session Gateway, which translates between the DSM-CC world of the SRM and the CORBA-based ISA world. The SRM cannot answer the question “which resources should be used;” it merely answers whether a resource can be used. To set up a session, the BMCS must identify to the SRM the specific resources required, hence the need for a widget that answers the “which” question. Also, not all of the required resources are visible to the SRM (for example, Harmonic NSG boxes) and so must be managed by something within the VOD Server/BMCS.

The on-demand Manager of the present invention enables the cable service operator to configure and control one or more VOD Servers in order to provide the functionality required to ingest content files, set-up VOD sessions at subscriber request and record status information on VOD streams. The VOD Manager must be able to set up stream-based sessions in cooperation with existing cable network resource management systems. The resource allocator part of the VOD Manager allows the VOD Manager to do this intelligently, and to manage devices installed with the on-demand server that are not visible to the existing resource managers.

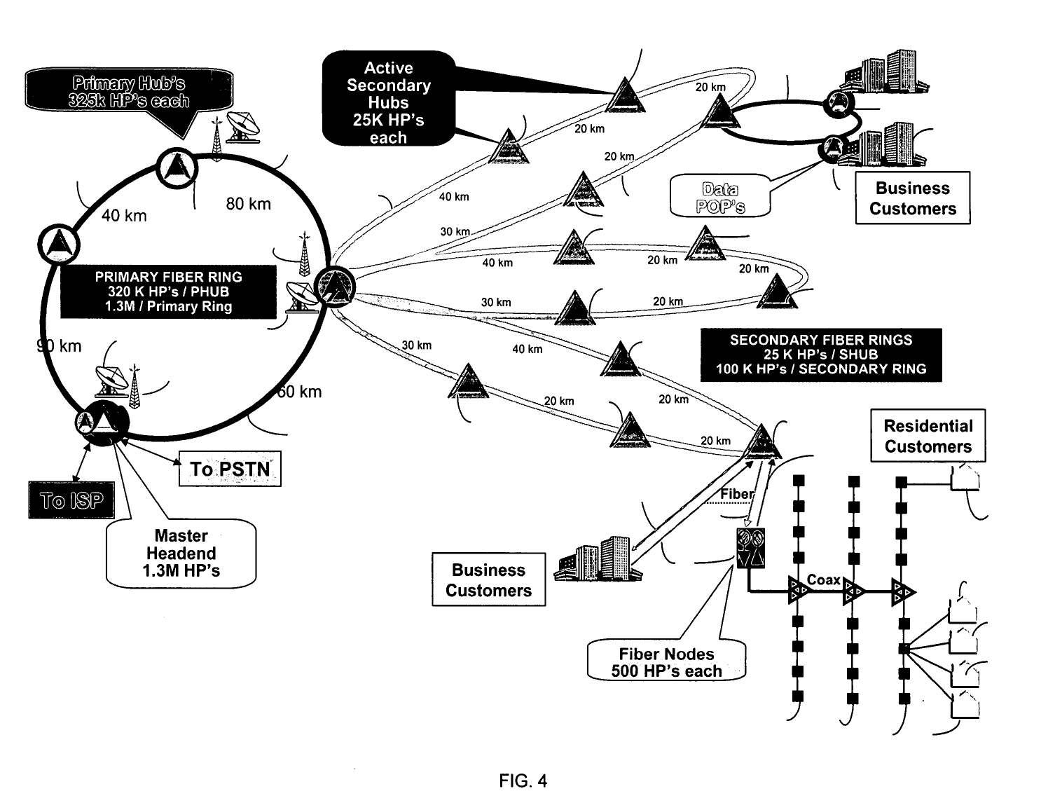

As is illustrated in FIG. 4, Certain functions and requirements are needed to provide network resource allocation and management & control system (BMCS) such as, for example, as deployed in an Telecommunications network. When integrated with a Telecommunications network, the MCS is configured to work with other third party devices or entities within the network to identify, reserve, and release the resources needed to deliver content to downstream DSL modems.

Referring to FIG. 4, an exemplary embodiment of the present invention illustrates the steps involved to stream content from the memory based on-demand server of the present invention. The B1 on-demand system is used to provide the streaming services consisting of up to ten slots populated with UPM cards. Each UPM card has 8 ports that can either be GIGABIT Ethernet GbE or Fiberchannel. GbE interfaces can be configured as storage interface that connect to storage via ISCSI. Fibrechannel can only be configured as storage interfaces. Storage contains the files of the MPEG-2 content that will be streamed. One card in the chassis is elected the chassis master. The master provides redundant control and management access to the system. In general, content objects are requested to start by the master who specifies the content to be played and where it should be played. The first time content is streamed it is brought into memory from NTS and built up in UPM content memory. At some point, while the content is being brought in, it will begin streaming out the GIGE interface. Subsequent, requests for the same content id already in memory are streamed from the copy already in memory. Referring, LSCP and stream setup commands come in via the 10/100 Ethernet management port. The internal commands required to execute the incoming requests are transported over the internal Ethernet control network. Initially a request for content, for example, a movie, is made and accepted by the AMS. In Step 1 (1) the request is made for the content 22. In step 2 (2) a request is made to set up a session structure to receive the MPEG-2 content of the movie file from NTS or LTS or from the BMS. In step 3(3), a memory address is requested. In step 4(4), a memory address is returned. In step 5 (5), an acknowledgement is sent for the memory request. In step 6 (6) a request for memory to stage an incoming movie. In step 7 (7), an acknowledgement is is sent for the memory request. In step 8(8), the requested file is brought from disk (NTS) or LTS to memory. In step 9(9), playout is started of the movie from memory. In step 10(10) tiles or pages of the content are brought into the MPM. In step 11(11) tiles or pages of the content are brought into the MPM. Build tiles into content in SPM memory. After a predetermined threshold of content is in memory, for example, 7 MPEG-2 tiles of about a 2 minutes, then playout can begin.

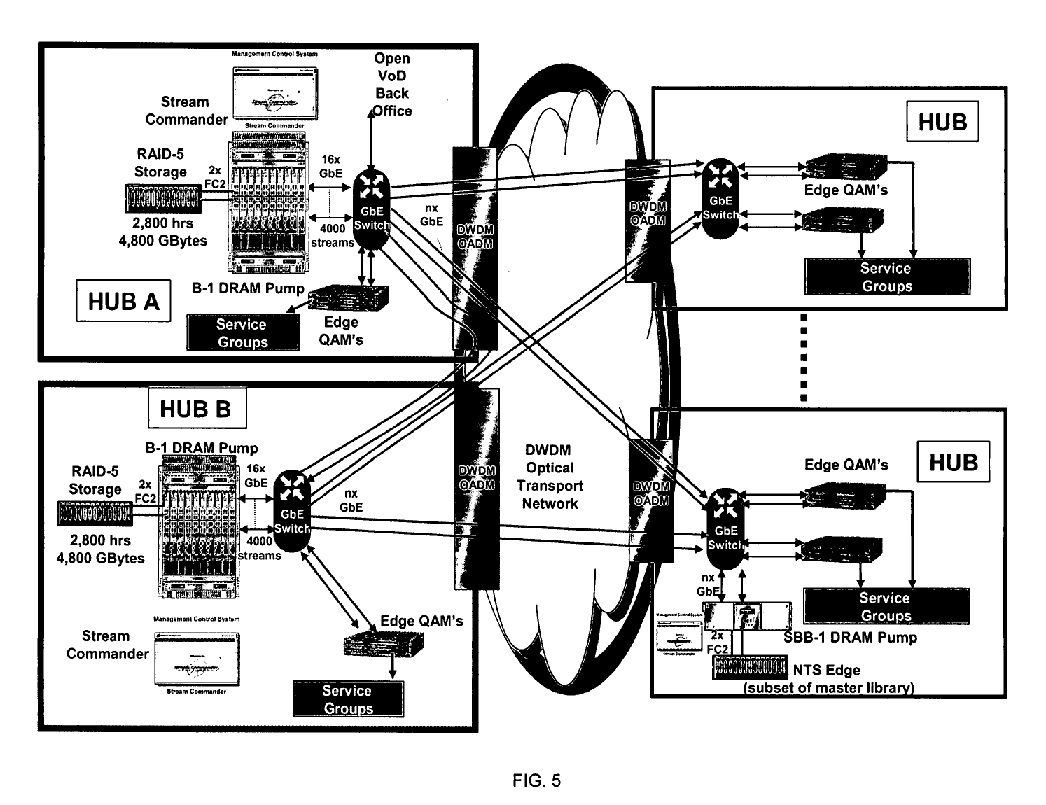

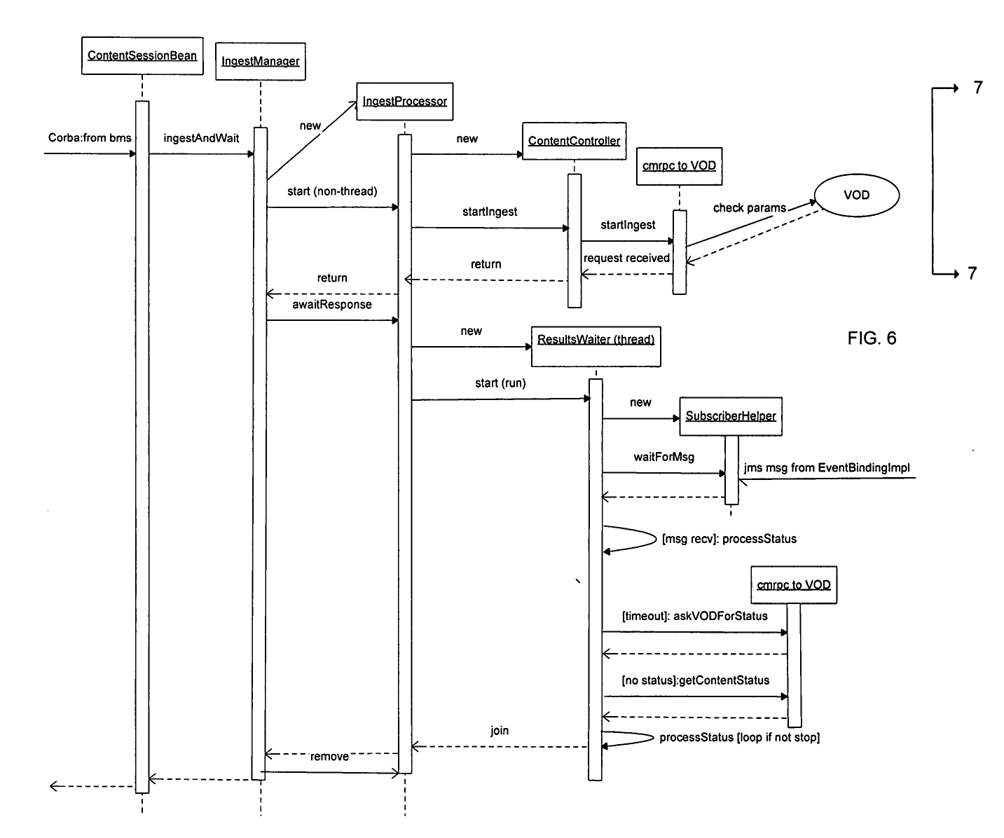

Referring to FIG. 5 and 6, is a block diagram illustrating managed services operator (MSO) metropolitan network distribution system and the controlling of streaming with a memory based on-demand server in a MSO metropolitan network distribution system according to an exemplary embodiment of the present invention. It is advaritageous to include the managing and controlling of stream software at the outerlying hubs to efficiently store a copy any content such that bandwidth between the hubs can be maximized pursuant to a customer request.

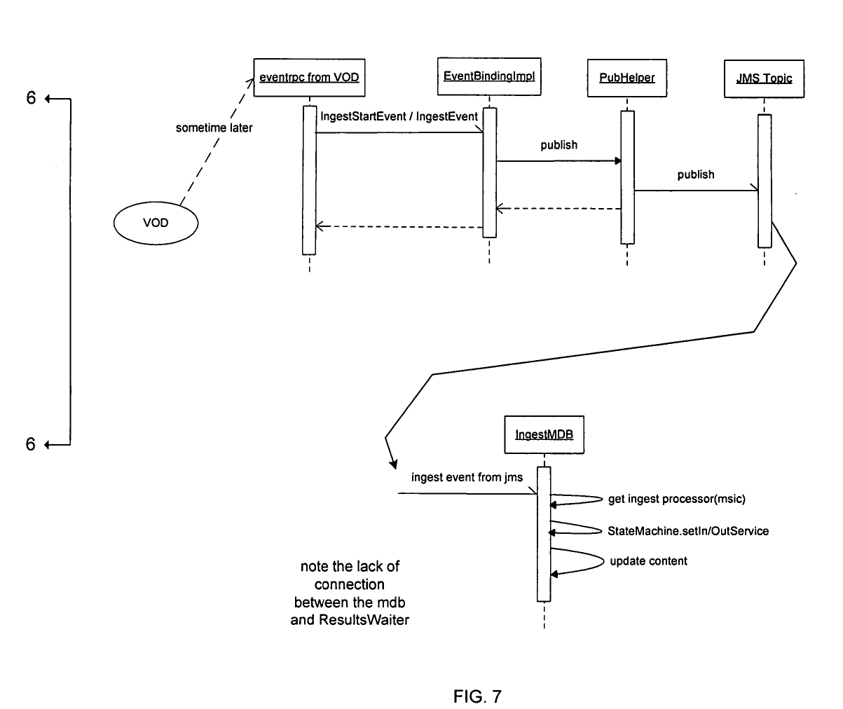

FIG. 7 is a flow diagram illustrating the ingest sequence controlling streaming with a memory based on-demand server. The streaming controller software of the present invention initially receives a ingest message from BMS. The follows steps illustrate a sample ingest and streaming of content:
1. IngestManager component receives the request and creates an lngestProcessor for each such message.
The IngestProcessor is set in a queue
2. IngestProcessor sends the startlngest message over the SOAP interface to the VOD server.
3. IngestManager send an awaitResponse to the IngestProcessor
4. The ingestProsessor creates A ResultWaiter which will wait for events about the ingest status.
The ResultWaiter registers to the JMS.
5. VOD server sends am lngestStart event over the SOAP interface to the EventBindinglmpl component on the Stream Commander.
6. EventBindinglmpl publishes the event on the JMS.
7. IngestMDB receives the JMS ingest start event and updates the bitrate and the status of the Content object
8. VOD server sends am IngestComplete event over the SOAP interface to the EventBindinglmpl component on the Stream Commander.
9. EventBindinglmpl publishes the ingestComplete event on the JMS.
10. IngestMDB receives the JMS ingest complete event and updates Content object
11. The ResutlWaiter component is also listening for these events.
12. After receiving the ingestComplete event. The lngestProcessor is removed from the queue
13. The BMS will receive the success or failure of the ingest as per the data in the ingestComplete event.
11a. If the Ingestcomplete event is not received in a preset interval, the ResultWaiter will ask the VOD server about the ingest status via the SOAP interface.
12a. The IngestProcessor is removed from the queue.
13a. The BMS will receive the success or failure of the ingest as per the data received in the getContentStatus request.

Other aspects of the stream commander software in conjunction with the memory based on demand server are described herein.

1. On-Demand Server Integration

a. On-Demand Server Configuration (Blades, Ports)

The system components required for managing and controlling the streaming from an on-demand server for the streaming controller of the present invention include a client-server architecture coupled to a BMS. The Client requirements include a web browser such as, for example, Internet Explorer 6.0 or later (Windows), Netscape Navigator 7.0 or later (Windows), or Mozzila 1.0.1 or later (Linux) with Java and Javascript enabled on such browser. The Server requirements include a computer with 512 MB RAM memory, a processor Pentium [6] 2.4 GHz processor Redhat Linux version: AS 3.0, and a database Oracle 10 g. stream control process requires the presence of the following ISA components to ensure integration within the headend: Catcher/Asset Management System (AMS), BMS, MOD Client/Server Applications (ShowRunner/XOD), and SA DNCS/SRM. The streaming controller software application hooks into the ISA bus by registering with the CORBA naming service running on the Business Management System (BMS). This enables direct communications with the BMS and other third-party ISA components. The streaming controller communicates with the on-demand server over the 10/100 Ethernet management port. The streaming controller Client provides an intuitive graphical user interface (GUI) that enables central management of one or more on-demand servers.

The streaming controller system can be determined initially for the configuration, monitoring and management of one or more on-demand servers, whereby the streaming controller process and/or application software features the ability to both set and view configuration parameters on servers and ensure that servers are online and accessible. The streaming controller process and/or application software also displays Hierarchical Object Trees that illustrate the one or more on-demand servers and device topologies, whereby such can be represented as selectable objects within collapsible explorer trees for point-and-click navigation across systems and components. Before one or more on-demand servers can be controlled and managed it must be added to the streaming controller process and/or application software that advantageously utilizes a browser-Based GUI enabling the management of on-demand servers from any supported network-accessible Web browser. The present invention can utilize a wizard to assist and easy add one or more on-demand servers by specifying the name and IP address of the server. In operation, the streaming controller process utilizes such defined name string to label each on demand server within GUI displays and uses such defined IP address to locate each on demand server. During an add operation, the streaming controller adds each on demand server to its local database and attempts to synchronize with the server to obtain the latest topology and configuration. The management IP address of each on demand server can also be coded through the system Command Line Interface (CLI) using the shelf ip address command and verify the current management IP address using the show shelf command. If the IP address is not reachable, then the added on demand server to the server database will appear but it will be unable to synchronize with it to obtain the latest configuration. A failed sync operation returns the following error: Failed to synchronize with on-demand server use Sync button on server configuration. If this message appears, ensure that the on demand on-demand server is online to perform a manual sync operation against the newly added server before adding new on-demand servers the storage cluster must be added to the associated on-demand servers.

The process for managing and controlling the streaming from the on-demand server is configured with a graphical user interface (GUI) in a Web browser running on a workstation that has network access to the streaming controller application server and provides a real-time listing of alarms and events across all on-demand systems. Access to the streaming controller software is provided by a welcome page and password protection. The GUI generally has menu bar, object tree and provides a visual indication of current alarm conditions as follows:
Red—Illuminates to indicate that at least 1 critical alarm exists.
Magenta—Illuminates to indicate that at least 1 major alarm exists.
Yellow—Illuminates to indicate at least 1 major alarm exists.
Green—Illuminates to indicate there are no critical or major alarms.

The streaming controller process and/or application software can have Control Room page, stream control Menu Bar page, and Object Tree page. The Control Room page provides a real-time listing of alarms and events across all systems. The Object Tree page provides a hierarchical representation of on-demand server systems and allows for easy navigation across system components. The stream control Menu Bar page provides access to stream control primary functional areas, thereby remaining accessible throughout all displays that launch in the stream control main window, with such menu bar page also includes: Server Management, Services, Control Room, Resources, Administration, Reports, Help, and Logout.
The Server Management menu heading provides access to the Object Tree and other configuration screens associated with each object such as, for example, the left pane displays the Object Tree while the right pane displays the available configuration screens associated with the selected object.
The Services page menu heading provides access to the Assets menu option. Selecting the Assets menu option displays the Asset List. The Asset List describes the content ingested into all on-demand servers under the streaming controller process.
The Control Room menu heading launches the streaming controller process Control Room. The Control Room provides a complete real-time listing of all alarms received by the streaming controller process running on the server including: an alarm summary, alarm list, and filters that enable you to customize the display.
The Resources menu launches a resource allocator through a GUI that provides enables end-to-end stream resource allocation on any path between a server port and service group so as to provision stream control with the topology information that it needs to intelligently track, monitor, and manage server and QAM resources.
The Administration menu heading provides access to user administration and streaming controller process administration tools. A User menu option launches User Administration tools to manage user accounts and to control access to the system. Selecting a Maintenance option accesses stream synchronization, content synchronization, and stream delete functions.
The Reports menu provides access to stream history and usage reports. Selecting the Stream History menu provides a view of the complete list of streams that were previously active but for which the session on the QAM has been torn down. Selecting the Reports menu option accesses session history, movie usage, and set top box (STB) usage reports.
The Help menu provides access to Help and About menu options. Selecting the Help menu launches stream control online Help supporting explorer tree contents, index, and other search features. Selecting the About menu option launches a dialog box that displays version and trademark information for the current stream control application.
The Logout menu exits the streaming controller process application thereby ending the current user session.
   Advantageously, the Object Tree provides a hierarchical representation of the on-demand servers under streaming controller process management. The object tree enables point-and-click navigation across multiple on-demand servers and supporting components using the object containment hierarchy.

b. Discovering the On-Demand Server Configuration

The process for managing and controlling the on-demand server includes a dynamic discovery of each on-demand server topologies (blades and ports) and current configuration values and it can be on a Server Topology Discovery page. Moreover, a region is a logical grouping of one or more headends enabling configuration of the name and description of the selected region. In the stream control process object hierarchy, a headend is a logical grouping of one or more on-demand servers. The headend object provides access to the following screens:
Configuration—Enables configuration of the name and description for the selected headend.
Storage—Enables configuration to display and delete storage IP addresses contained within the selected headend. The screen is configured in one embodiment to display ISCSI storage. If Fibre Channel storage is used, this display is intentionally left blank.
Ingest—Enables display of the total number of active ingests for each on-demand server within the selected headend.

A storage cluster is an administrative grouping of one or more on-demand servers that share the same external storage. The on-demand server storage cluster object provides access to screens enabling the provision of the cluster and information about storage volumes contained in the cluster. Tabs at the storage cluster level of the object hierarchy include:
Configuration—Enables configuration of the name and description for the selected storage cluster. The configuration screen also enables entering the name assigned to the selected content store as configured on the Business Management System (BMS).
Storage—Enables configuration to display and delete the storage IP addresses of all external storage arrays in the cluster. The screen is configured in one embodiment to display ISCSI storage. If Fibre Channel storage is used, this display is intentionally left blank.
Content—Displays information for all storage volumes in the cluster.
Ingest—Enables active ingests for the selected storage cluster.

A server object represents an on-demand server and provides access to the following screens:
Configuration—Enables configuration to view and configure server parameters.
Streams—Enables displaying active streams for the selected on-demand server and provides access to stream details.
Alarms—Enables displaying alarms that the streaming controller process has received for the selected server and provides access to alarm details.
Storage—Enables displaying volume information for external storage system(s) used by the selected on-demand server.
Blades—Enables displaying summary information for blades contained in the on-demand server

A blade object represents a single on-demand server blade and provides access to the following screens:
Configuration—Enables configuration to view blade parameters, configure the name and description associated with the blade, and manually set the administrative state.
Streams—Enables displaying active streams for the selected blade and provides access to stream details.
Alarms—Enables displaying alarms that the streaming controller process has received for the selected blade and provides single-click access to alarm details.
Port Stats—Enables displaying summary information for all ports on the selected blade, including port state, active streams, resets, bandwidth and port type.
Routing Table—Enables displaying the static IP routes configured on the Ethernet management port of the selected blade.

A port object represents a single port, or network interface, on the on-demand server and provides access to the following screens:
Configuration—Enables configuration to view and configure port parameters.
Streams—Enables displaying If the port is configured for streaming, this screen displays the active streams on the selected interface and provides single-click access to stream details.
Alarms—Enables displaying the alarms that stream control process has received for the selected port and provides single-click access to alarm details.
Storage—Enables configuration to assign (add) and unassign (remove) storage IP addresses for a selected storage interface. The screen is configured in one embodiment to display ISCSI storage. If Fibre Channel storage is used, this display is intentionally left blank.
Routing Table—Enables displaying the static IP routes configured on the selected port.
ARP Table—Enables displaying the static Address Resolution Protocol (ARP) entries configured on the selected port.

As shown in FIG. 9, the stream control process establishes a Client-Server architecture through a browser-based GUIs to render data in easy-to-understand displays, facilitate configuration of key server parameters, and the Clients provide for sync, save, and refresh operations. The sync operation retrieves the current configuration from the on-demand server and writes the information to the local database, thereby enabling updating the stream control process with the most current information from the on-demand server. The save operation writes the values that you supply in configuration fields to the local database and downloads any modified values to the on-demand server, thereby enabling configuration of basic server parameters. The refresh operation updates the current display with the latest information from the stream control process database, thereby ensuring the most recent data is available.

c. Content Synchronization

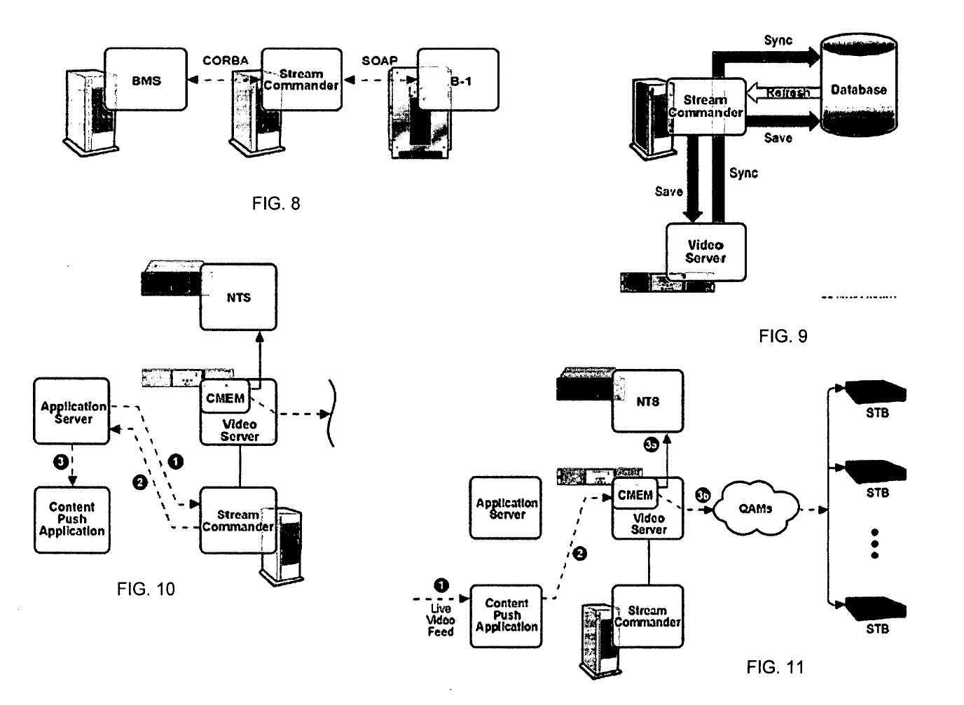

As shown in FIG. 8, the stream control process can perform a content synchronization, a stream sync operation, which advantageously can be periodically performed against each video server to remove unknown or illegal (not know by stream control process) streams. The stream sync operation ensures that only content that stream control process can use is contained on NTS disk. The stream sync operation enables the user to synchronize content between the stream control process database and the on-demand server, whereby the synchronization process compares the content list contained on both entities, and then removes any content from near term storage (NTS) that is not listed in the stream control process database.

d. Stream Synchronization

As shown in FIGS. 9-12, the stream control process can perform a stream synchronization, a Stream Sync operation, whereby the stream control process uses the Stream Sync operation to retrieve current configuration parameters and properties from the selected server. Stream control process enables synchronizing streams (Stream Sync) to ensure that only the streams that stream control process knows about are utilizing on-demand server resources. The stream control process can be configured to perform the Stream Sync operation initially log into the system, after adding the on-demand server to be managed to the stream control process and then performing a Stream Sync operation to discover the on-demand server's topology and configuration. In operation, the content sync operation retrieves the list of active streams on the on-demand server and compares it with the current list of streams defined in the Stream Commander database. The results of the content sync operation are used in the stream control process which then automatically deletes from the on-demand server any streams that are not on record in the stream control process database.

In operation, the procedure to add and synchronize the on-demand server includes: step 1, entering the name, management IP address, and network mask for the on-demand server to be added; (2) In the stream control process, selecting the Storage Cluster to which this headend belongs; and (3) perform the stream (sync) operation. When performing a Stream Sync operation on 1024 streams, the user specifies a Stream ID from where to start the stream synchronization process; stream control process synchronizes 1024 Stream IDs at a time starting with the Stream ID specified as the starting point for Stream Sync. For example, if the operator specified 10000 as the ContentID from which to start synchronizing, a stream control process retrieves a list of streams that have Stream ID values from 10000 to 11024, and deletes any stream that exists on the on-demand server but for which stream control process has no record.

The streaming controller process and/or application software can perform a stream sync operation against each on-demand server to remove unknown or illegal (not know by stream control process) streams, whereby the software can instruct the user to perform a stream sync operation, by following these steps:
1. Log into stream control process as described in Log In.
2. Select Administration>Maintenance from the main menu bar.
3. In the Stream id to start synchronizing from field, enter the Stream ID at which to start synchronizing.
4. From the Select the server you wish to synchronize drop-down list, select the server to synchronize.
5. Click Sync. Response: A dialog appears prompting you to confirm the sync operation.
6. Click OK to synchronize streams.

e. Events/Alarms from On-Demand Server

The Control Room page of the streaming controller process and/or application software provides a complete real-time listing of alarm conditions and events across all on-demand server systems in several categories including SNMP Event Notifications, Multi-Level Alarm Views, Alarm Severity Levels, and Alarm Details. The Alarm categories provide real-time alarm monitoring at the server, blade, and port component levels and supportive drill-down menus to detailed alarm information. For example, streaming controller process and/or application has enabled dynamic notification of on-demand server events using Simple Network Management Protocol (SNMP) Traps and captures such information and populates the Stream database. The streaming controller process and/or application can report alarms in categories of Alarm Severity Levels such as, for example, Critical, Major, Minor, and Informational. Moreover, the software can visually display Alarm Severity Levels in a Traffic Light icon shown in the upper-right corner of the streaming controller process display provides a visual notification of the highest level alarm condition reported by any server in the stream control process management domain. Alarm counts next to each severity light indicate the total number of active (uncleared) alarms as follows:
Red—Indicates the total number of critical alarms that have not yet been acknowledged or cleared.
Magenta—Indicates the total number of major alarms that have not yet been acknowledged or cleared.
Orange—Indicates the total number of minor alarms that have not yet been acknowledged or cleared.
Green—Indicates the total number of informational events that have not yet been acknowledged or cleared.
   Alarms can be determined and viewed from the server, blade and port levels and these can be acknowledged and cleared by a responsible operator.
Acknowledged—Select Acknowledge from the pull-down list to mark the alarm condition as being acknowledged or select Unacknowledged to mark the alarm condition as not yet being acknowledged.
Acknowledged By—Optionally, you can enter the name and contact information of the administrator or operator who has acknowledged the alarm.
   2. Multiple On-Demand Servers

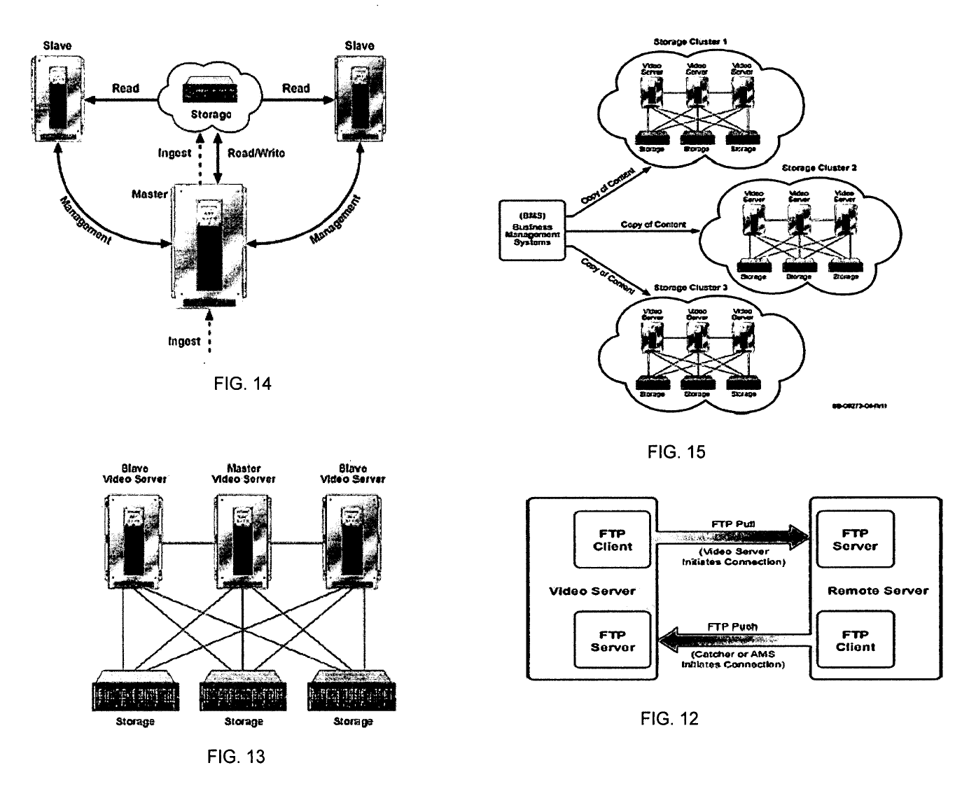

As shown in FIG.13-15, the streaming controller process and/or application software provides for a storage cluster or other administrative grouping of one or more on-demand servers that share the same external storage. A cluster typically consists of multiple storage arrays with each array holding one or more storage volumes. Each on-demand server in the cluster can load and stream content from any storage volume contained in the cluster. A storage cluster consists of the following elements:
master on-demand server—At least one on-demand server must be assigned as cluster master. The master is responsible for ingesting content into the cluster and notifying the other on-demand servers of changes in the content library.
slave on-demand servers—Slave on-demand servers are not allowed to perform ingest or write operations but can load and stream content contained on any array.
external storage arrays—Each RAID 5 storage array can be configured with one or more storage volumes. Each storage volume contains a unique inventory of contents that all on-demand servers in the cluster can access.
   The master on-demand server has communication with all slave on-demand servers. All on-demand servers in the cluster have access to all storage arrays. Only the master on-demand server can ingest content and write to external storage; slave on-demand servers have read-only access as shown in FIG. 13. The master on-demand server is connected to each slave on-demand server through an Ethernet connection to each on-demand server. Each on-demand server in the cluster connects to each storage array using one or more Gigabit Ethernet ISCSI or Fibre Channel storage ports. FIG. 14 required connections between on-demand servers and storage arrays in a cluster. The Business Management System (BMS) views each storage cluster as a single content store. When multiple clusters exist, each cluster receives its own copy of content as is shown in FIG. 15.

Initially, stream control process ships with a default storage cluster already added to the stream database labeled as StorageCluster1 in the object tree. Any other on-demand server added to the stream control process thereafter can belong to the default storage cluster or assigned a new cluster by adding entering a name and description for the new storage cluster and refreshing the Object Tree will show the new cluster. Each additional on-demand server added to the stream control process creates a multiple storage cluster, whereby multiple storage clusters reflect how any on-demand servers and storage arrays are physically grouped. Moreover, all on-demand servers in a storage cluster share the same external storage or otherwise have a shared content library, whereby on-demand servers within a storage cluster can stream content contained on any storage array in the same cluster enabling multiple on-demand servers to share the same content libraries, and advantageously, eliminate the need to propagate content across multiple server systems. The cluster makes new content available to all on-demand servers using a single content ingest, as shown in FIGS.13-15. The stream controlling process for managing and controlling multiple on-demand servers advantageously does not have to ingest content into each on-demand server separately. Only the master on-demand server can ingest and save content to external storage arrays. Slaves can load content from storage but cannot write content. During ingest operations, the master on-demand server round-robins across available storage arrays in the cluster so that disk space is equally utilized across the arrays. The master maintains management communication with all slaves over a 10/100 Ethernet connection to each on-demand server. If the master on-demand server loses communication to any slave, stream control process views the entire cluster as down. When a cluster is down, stream control process disallows the following operations: new stream creations, new ingests, content deletions, and formatting of storage volumes.

As shown in FIG.14, the process for managing and controlling multiple on-demand server includes a storage volume to remain online and accessible, all on-demand servers must be able to access it. If any on-demand server loses connection with a storage volume, that storage volume is considered down and inaccessible for all on-demand servers in the cluster. When a storage volume is down, the master cannot write to the volume and content contained in the storage volume cannot be streamed. During subsequent ingest operations, the master on-demand server will round-robin against the remaining available arrays in the cluster. The process for managing and controlling multiple on-demand server includes a dynamic adding server content when the master on-demand server ingests new content, it sends a content add notification to each slave on-demand server in the cluster to inform the slave servers that new content has arrived. The add notification includes the name and location of the new content. Armed with this information, each slave on-demand server can now access and stream the content as if they had ingested it themselves. In addition to sending notification whenever new content arrives in the cluster, the master on-demand server also sends notifications when a content is deleted, or when a storage volume is renamed or formatted. This ensures that all on-demand servers within the cluster remain synchronized.

Cluster configuration involves specifying one on-demand server as master and one or more on-demand servers as slaves. stream control process facilitates provisioning of storage clusters by allowing you to specify the on-demand server to function as Master, then automatically defaulting the remaining servers in the cluster to slaves. If only a single on-demand server exists in a storage cluster, the on-demand server functions as its own master and is considered a cluster of 1, in which case no additional configuration is required. If you have added more than one on-demand server to the same storage cluster, you must perform the configuration described in this section. You can delete storage clusters that you no longer need. When you delete a storage cluster, all on-demand servers within the cluster are removed as well. To remove a storage cluster from stream control process, follow these steps:
1. Log into stream control process as described in Log In.
2. In the object tree, select the storage cluster that you want to delete.
3. Click the Delete button.
4. Click Yes.
Response: The selected storage cluster is removed from stream control process.

a. Configure a On-Demand Server Cluster

Storage Cluster—An administrative grouping of on-demand servers that share the same external storage. Enables multiple on-demand servers to use the same external storage volumes.

b. Configure Multiple Standalone VOD Servers

3. BMS Integration

a. Ingest Content

FIG. 12 illustrates Pull Ingest Pull ingest refers to the ability of the on-demand server to initiate content transfers into the system. Push Ingest Push ingest refers to the ability of the on-demand server to accept content transfers initiated from a remote server.

4. Additional SC Functionality

a. Manual Ingest on VOD Server

The stream control process enables you to perform manual asset ingests. During the manual ingest operation, stream control process performs a pull content ingest operation. Pull content ingest refers to the ability of the master on-demand server in the storage cluster to connect to a remote system (such as a catcher or Asset Management System) and initiate transfer the content into the storage cluster. As part of the manual pull ingest operation, you must specify the FTP URL of the content file. stream control process downloads this URL to the master on-demand server. The on-demand server then uses this URL to initiate FTP transfer of the content file as shown in FIG. Manual content ingest overrides normal ISA channels and is provided for testing and integration purposes only as 1. On-demand server initiates an FTP connection to the remote server (catcher); and

2. Content is transferred to the VODserver using FTP.

b. Manual Trick Commands on On-Demand Server via SOAP

The streaming controller process and/or application software provides for streaming from the on-demand servers stream directly from Dynamic Random Access Memory (DRAM). Before the on-demand server can stream content, it must retrieve the content from near term storage (NTS) and load it into memory. As is explained more fully in copending U.S. patent application Ser. No. ______, the on-demand server of the present invention can support two content management modes that dictate how content is handled within the system during stream operations: content paging and memory resident content. Content paging is the process by which the on-demand server loads into memory only the portion of content it requires to stream at a given moment. Content paging helps to conserve on-demand server DRAM when supporting high numbers of unique content streams. When paging content, the on-demand server logically segments the content into 8 MB portions-referred to as tiles—and retrieves from NTS only the tiles that it needs to stream at a given moment. As tiles are streamed, they are removed from memory and replaced with new tiles as required for seamless continuity of the stream. Memory resident content involves loading the entire content file into memory and keeping it there until streaming is complete. Memory resident content helps to maximize performance when the same content must support high numbers of streams. The on-demand server dynamically marks as memory resident only content that is servicing the most streams. When content is marked as memory resident, the on-demand server loads the entire content file into memory and keeps it there; this prevents the on-demand server from having to continuously retrieve portions of the content from external storage. The ability to stream both paged and memory resident content enables intelligent utilization of on-demand server DRAM to ensure the highest performance for the most popular content, whereby the on-demand servers use a dynamic paging algorithm to determine which content to make memory resident and which content to page. Dynamic content paging refers to the on-demand server's ability to swap content between paging and memory resident modes as it determines which content to page and which content to mark as memory resident. The on-demand server makes this determination based on use count. This dynamic paging algorithm prevents you from having to manually designate which content to page and which content to make memory resident. Use count is defined as the number of streams currently playing the content. For example, if two streams are playing the same content that content has a use count, or concurrency, of two. Only content with the highest use counts are marked as memory resident. As additional streams are created and use counts fluctuate, content is automatically swapped between memory resident and paging modes so that only contents possessing the highest use counts are memory resident. This ensures the greatest performance for content servicing the highest number of streams. Memory resident content remains in memory until replaced by content with a higher use count at which time the displaced content reverts back to paging mode.

5. Stream Management

a. Active Streams

As shown in FIG. 5-6, the streaming controller process and/or application software provides the ability to view currently active and suspended streams at multiple component levels for all on-demand servers. Streams are considered active when they are playing out a on-demand server port and utilizing QAM resources. The streaming controller process supports the ability for the on-demand server to provision multiple or otherwise stream multiple content objects (Multi-Content Object Streams) as part of a single stream. In the case of provision multiple streams, a screen (Stream Detail) displays the multiple content pieces that comprise the stream. The streaming controller process provides the ability to manually create, play, delete, and control streams in the (Manual Stream Creation and Control) currently active and to suspended streams for trick play functions including stop, pause, fast-forward and rewind. The streaming controller process provides real-time statistics for stream activity on each on-demand server. Moreover, as described herein, the user can synchronize active streams (Stream Sync) between stream control process and the on-demand server so that on-demand server resources are only used for valid streams—streams initiated by stream control process as a result of normal ISA operations.

b. Stream History

The streaming controller process and/or application software provides the ability to view the complete stream history for all on-demand servers. As streams are destroyed they are removed from the active stream table and placed in the Stream History report. Moreover, as described herein, the user can generate reports for valid active streams—streams initiated by stream control process as a result of normal ISA operations.

6. Content Management

The streaming controller process and/or application software provides the ability to view a complete listing of assets (Asset List) that have been ingested into all on-demand server systems. The streaming controller process and/or application software provides the ability to view storage management features enable you to view and manage content contained in near-term storage (NTS) volumes (Storage Management). The streaming controller process and/or application software provides the ability to view synchronize content (Content Sync) between stream control process and the on-demand server to ensure that near term storage (NTS) only contains content that stream control process can use.

a. Assets

The streaming controller process and/or application software provides the ability to displays detailed information about the selected asset and enables you to perform the following actions:
Manually set the status of the asset to one of the following:
In Service—Sets the state of the asset to in service. When an asset is set to in-service, stream control process makes it available for streaming.
Out of Service—Sets the state of the asset to out of service. When an asset is set to out of service, stream control process makes the asset unavailable for streaming. Any current streams against the selected asset will continue until complete, but no additional streams can be created using this asset.
Configure a third-party identifier for the selected asset.
Launch content details for the selected asset.
   Enables you to assign a unique ID to the asset as required for integration purposes. stream control process uses an internal indexing scheme to identify the asset within the Broadbus on-demand server system so typically you do not need to set this parameter. If, on the other hand, you require the asset to have a specific ID, you can use this field to assign the required value to the asset stream control process then keeps a mapping of Third Party ID to internal index number so it can respond to requests that identify the asset using the Third Party ID. Enables you to manually set the state of the asset within Stream Commander to one of these values:
In Service—The asset is available for streaming (Default).
Out of Service—The asset is not available for streaming. Any streams currently using the asset will complete; new streams cannot be created against this asset until the state is set back to In Service.
   Setting the asset state to Out of Service does not delete the asset from the system. Instead, it simply tags the asset as unavailable so that new streams cannot be creating using the asset. Saves the new configuration to the stream control process database. Note that any values that you change in this screen do not take effect until you click the Save button to submit the configuration. The ingest state for the current asset, as defined by the following values:
Queued—Include only content currently queued for ingest.
Ingesting—Content is currently ingesting.
Ingest Complete—Ingest has completed and the entire content is now contained in near-term storage.
Ingest Failed—Ingest has failed and content is not contained in near-term storage.
Ingest Cancelled—Ingest was manually cancelled by stream control process operation. To cancel an ingest, click the Stop Ingesting button within Content Detail.
The state of the stream on the on-demand server, including one of the following values:
Ready—Stream is ready to play.
Not Ready—Stream is not ready to play and must enter the Started state before streaming can begin)

The streaming controller process and/or application software provides a Configuration tab at the blade level to access to key blade parameters, which is important in the stream control process for the on-demand server's topology, including blade and ports. The streaming controller process is configured to verifiy that each port is online and configured to perform its intended function—ingest, stream, ingest and stream, or storage. The streaming controller verification process discovers the correct on-demand server's topology and ensure that the blade and ports are online and configured to perform their intended functions, as follows:
1. Verify that all on-demand server blades appear in the object tree.
2. For SBB-1, you should see a single blade.
3. For B-1, you should see one or more blades depending on your system configuration; one of those blades must be labeled as Master.
4. Blades are on-demand server network interface modules. The SBB-1 consists of a single fixed blade and the B-1 can contain up to 10 blades.
5. Each blade is equipped with the following network interfaces:
up to 8 Gigabit Ethernet or Fibre Channel ports for ingest, storage, and streaming functions.
1 10/100 Ethernet port for IP-based management access

b. Ports

The streaming controller process and/or application software provides provides a Configuration tab at the port level so as to determine and configure port connectivity. Ports are the physical interfaces that provide network connectivity. Blades are available in both 4-port and 8-port configurations and come equipped with Gigabit Ethernet ports, Fibre Channel ports, or both. While Fibre Channel ports are only used for connection to external storage, Gigabit Ethernet ports can be configured to perform one of the following functions:
Ingesting—Ingest content from a remote server or catcher.
Streaming—Stream content to destination service groups.
Storage—Interface with attached external storage systems.
Streaming and Ingesting—Perform both ingest and stream functions as required.
   During a sync operation, the stream control process discovers the ports that are installed on each blade and dynamically retrieves the configuration properties associated with each port, thereby the configuration screen can be utilized at the port-level of the object hierarchy to view and set port parameters.

c. Ingest

Content ingest is the process of ingesting physical content files (MPEG-2, etc.) into the on-demand server system (SBB-1™ or B-1™) for streaming and storage. The system uses File Transfer Protocol (FTP) to transfer content from a remote server (such as a catcher) to one or more ingest ports on the on-demand server. The system supports both FTP “pull” and FTP “push” content ingest. In the FTP “pull” content ingest process, the on-demand server essentially functions as an FTP client and initiates transfer of the content from the remote server. In the FTP “push” content ingest process, the on-demand server functions as an FTP server and allows a remote client to initiate FTP transfer of the content to the on-demand server, Pull content ingest refers to the ability of the on-demand server to pull content from a remote server (catcher). Pull content ingest is typically used within video on demand applications where content already exits and is available ahead of time.

In a pull ingest operation, stream control process provides the on-demand server with the FTP URL describing the location of the content. After receiving this URL, the on-demand server initiates transfer of the content from the remote location.
1. Catcher receives content package.
2. Catcher sends BMS the FTP URL required to transfer content from catcher to on-demand server.
3. BMS forwards FTP URL to stream control process over CORBA interface.
4. stream control process forwards FTP URL to on-demand server over SOAP interface.
5. SBB-1 uses FTP URL to initiate transfer of content from catcher into server memory (referred to as content memory or CMEM).
6. As content is loaded into server memory it is saved out to the attached near term storage (NTS).
After the entire content file is written to NTS, the ingest process is complete. The content is now ready to stream.
   Push content ingest refers to the ability of a remote server to initiate an FTP transfer with the on-demand server and push content to the system. Push content ingest is typically used to ingest and stream live content feeds as they arrive at the headend. In a push ingest operation, stream control process provides the remote server with the FTP URL describing the location to where the new content must be copied. The on-demand server then waits for the content and when it arrives, allows the remote server to initiate transfer of the content (push) into the on-demand server using the pre-defined URL. FTP “push” content ingest involves pre-configuring the on-demand server to receive specified content, then configuring the server to allow a remote client process to initiate an FTP transfer of the content using a predefined URL. This two-step process includes:
   Provisioning for FTP Push
   Transferring Content to the Video Server
1. A third-party application sends stream control process information describing the content to be ingested. Parameters passed to stream control process include bit rate, play time, and expected start time of the file to be ingested, and can also include the content name.
2. stream control process returns the FTP URL that theremote system must use to transfer the content when it arrives.
3. The third-party application forwards the URL to the content push application.
   Transferring Content to the Video Server.
1. The content push application receives the live video feed and encodes it into MPEG-2 format, delineating the start and end of the content files to be transferred.
2. The content push application then initiates FTP transfer of the content directly to the SBB-1 ingest port defined in the FTP URL.
3. As the on-demand server receives the content, it loads it into server content memory (CMEM) then uses the Broadbus live ingest capability to simultaneously save the content out to the attached near-term storage (3a) and stream the content, if requested (3b).

d. Volume

Viewing Ingest Activity for a Headend. Ingest information at the headend level provides the number of active ingests for each on-demand server within the selected headend. To view ingest activity for a selected headend, follow these steps:
1. Use the object tree to navigate to the selected headend.
2. Click the Ingest tab.
   Response: The total number of ingests for each on-demand server within the selected headend is displayed.
   Viewing Ingest Activity for a Storage Cluster. The ingest tab at the storage cluster level displays the currently active ingests for the selected cluster. To view ingest activity for a selected storage cluster:
1. Use the object tree to navigate to the selected storage cluster.
2. Click the Ingest tab.
   Response: The list of active ingests for the selected cluster is displayed.
   7. Database Import/Export

The streaming controller process and/or application software stores stream information in an Oracle SQL database (Stream database). The database resides on the stream control process application server and contains on-demand server configuration information, statistical data, alarms, stream history and suspended stream information. To help conserve database resources, stream control process runs an automated purging process that removes obsolete data at pre-defined intervals:
Alarms—Alarms are purged from the stream control process database every 7 days. This means that alarms that are more than one week old are automatically deleted from the database.
Stream History—Stream History entries are purged from the database every 7 days. This means that stream entries more than 1 week old are removed from the Stream History report.
Streams—Streams are purged from the stream control process database every 24 hours. This operation also removes streams placed in the suspended state as a result of stop or pause commands issued from remote set top boxes.
When a stream is stopped at the request of the STB, the stream session is torn down and stream control process records the point in the content that the stream stopped playing. When the STB sends a resume command to begin playing the stream, a new stream session is created and the stream resumes playing where it left off.
   8. SNMP Agent

The streaming controller process and/or application software trap event notifications from the one or more on-demand servers to generate generate event notifications to alert you to configuration changes, state transitions, and error conditions as they occur on the video server. The system can send these notifications to remote hosts in the form of Simple Network Management Protocol (SNMP) traps. Each on-demand server sends event notifications to stream control process over the Simple Object Access Protocol (SOAP) interface. The stream control process then saves a copy of the event notification to its local database and passes a copy to the SNMP agent running on the stream control process application server. Stream Commander uses the copy contained in its database to populate Graphical User Interface (GUI) alarm displays; the SNMP agent translates its copy of the notification into an SNMP trap then forwards the trap to all hosts defined in the trap forwarding table.

a. JBoss

The streaming controller process and/or application software forwards the trap event notifications from the one or more on-demand servers to IP host destinations using The trap forwarding table defines the IP host destinations to which Stream Commander forwards SNMP traps. You can view and edit the trap forwarding table as described in the following procedures:
arg0—Destination IP address. Valid value: IP address.
arg1—Port (port to send trap out on; 8003 recommended)
arg2—SNMP version; valid values: 1 or 2.
arg3—SNMP community string
arg4—Retries (not used, but must enter 1)
arg5—Timeouts (not used, but must enter 1)
   The streaming controller process and/or application software creates reports (On-Demand Report Generation), thereby generating a view of the content and stream usage statistics for a specified time period.

The catcher receives content in the form of content packages. Each content package is stored in a directory and contains both an XML file describing the content and the content file itself. Manual content ingest using Stream Commander requires that you specify the FTP URL to the content file. If you do not specify a title in the Title field of the manual ingest window, you must also specify the XML file associated with the content file, in which case the XML file must be named XML.ADI.

Although exemplary embodiments of the present invention have been shown and described with reference to particular embodiments and applications thereof, it will be apparent to those having ordinary skill in the art that a number of changes, modifications, or alterations to the invention as described herein may be made, none of which depart from the spirit or scope of the present invention. All such changes, modifications, and alterations should therefore be seen as being within the scope of the present invention.

1. A system for controlling streaming of content from an on-demand server comprising:
a processor;
memory coupled to said processor;
said memory having stored therein an array of ordered values, wherein the array of ordered values has a first value and a last value;
said processor being configured to ingest the content over a protocol bus;
said processor being configured to repeatedly (a) establish a content session for obtaining content by interfacing with a business management system (BMS); (b) ingest content as an object by interfacing with an asset management system AMS and/or a catcher; and/or (c) ingest movie-on-demand MOD APPS; and
said processor being configured to control the streaming of the content stored in memory of the on-demand server to a customer on-demand.

2. The system of claim 1, whereby said processor communicates with said on-demand server over a port [such as a 10/100 Ethernet].

3. The system of claim 1, whereby the on-demand server has a substantial RAM memory.

4. The system of claim 1, whereby said processor ingests the content as an object and stores the content in said RAM memory of the on demand server by file transfer protocol (FTP).

5. The system of claim 1, whereby said processor is further configured to ingest the content and stores the content in disk storage such as Near Term Storage connected to the on demand server.

6. The system of claim 1, whereby said protocol bus is configured as Interactive Services Architecture (ISA) standard.

7. The system of claim 1, whereby said processor is further configured to interpret information of said protocol bus from one of a group of protocols of an Interactive Services Architecture (ISA) standard, a J2EE standard, a RTSP standard, a RTSP and LSCP standard, a RTSP and extended markup language XML.

8. The system of claim 1, whereby said processor is further configured to implement said content as an object according to the ISA standard and insures persistence.

9. The system of claim 1, whereby said processor is further configured to maintains information about all of the content 22 object files installed on the on-demand server.

10. The system of claim 9, whereby said processor is further configured to remove content object files installed on the on-demand server.

11. The system of claim 1, whereby said processor is further configured to maintain information about all of the content 22 object files installed on the on-demand server.

12. The system of claim 1, whereby said processor is further configured to create unique handle for the content object file, said unique handle of the content object file is maintained

13. The system of claim 12, whereby said processor is further configured to forward said unique handle of the content object file to the on-demand server.

14. The system of claim 1, whereby said processor is further configured to provide information concerning the content object file to the on-demand server including, but not limited to, bit-rate, path including one or more of ([define] URL containing IP address, user and password), and unique content ID.

15. The system of claim 1, whereby said processor is further configured to provide persistence for asset and information concerning the content object file to the on-demand server.

16. The system of claim 1, whereby said processor is further configured to notify the on-demand server about an ingest request concerning the content object file to the on-demand server.

17. The system of claim 1, whereby said processor is further configured to generate an alarm when an ingest request fails concerning the content object file to the on-demand server.

18. The system of claim 1, whereby said processor is further configured to generate a log of events including events concerning ingesting the content object file to the on-demand server.

19. The system of claim 1, whereby said processor is further configured to manage the content object file in the on-demand server.

20. The system of claim 1, whereby said processor is further configured to balance the content object file in one or more on-demand servers

21. The system of claim 1, whereby said processor is further configured to maintain concurrency of streams of the content object file.

22. The system of claim 21, whereby said processor is further configured to utilize said RAM memory efficiently across and/or between said one or more on-demand servers.

23. The system of claim 1, whereby said processor is further configured to schedule said ingesting of the content object file across and/or between said one or more on-demand servers.

24. The system of claim 1, whereby said processor is further configured to enable direct communications with the BMS, other third party components, and on-demand server components including server, blade and port status.

25. A method for managing and controlling streaming in an on-demand, memory-based server, comprising:
signaling an ingest manager of a business management system to request an ingest of content;
creating an ingest processor object for said request for said ingest of content;
queuing said ingest processor object to manage said ingest of content;
initiating a start ingest from said ingest processor object by sending a start ingest message over a SOAP interface to the on-demand server;
sending an await response from said ingest manager to said ingest processor object;
creating a result waiter by said ingest processor object where said result waiter waits for events about said request for ingest of content;
registering said results waiter with a JMS topic;
sending an ingest start event from the on-demand server to an event binding implementation component of said streaming controller over a SOAP interface;
publishing by said event binding implementation component said ingest start event on said JMS topic;
updating a database concerning a bit rate and status of said ingest of content when said JMS topic is received after said ingest start event;
sending an ingest complete event from the on-demand server to said event binding implementation component of said streaming controller over a SOAP interface;
publishing said ingest complete event of said JMS topic to said event binding implementation component;
updating said content object and said database after receiving said JMS topic concerning said ingest complete event; and
removing from said queue said ingest processor after receiving said ingest complete event.

26. The method of claim 25, further including the step of:
updating said results waiter with said JMS topic concerning said ingest complete event.

27. The method of claim 25, further including the step of:
updating said BMS concerning said ingest complete event after receiving a content status event from said ingest processor object about said request for said ingest of content.
